(19) United States
(12) Patent Application Publication
(10) Pub. No.: US 2025/0110324 A1
(43) Pub. Date: Apr. 3, 2025

(54) RAMAN MICROSCOPE AND METHOD FOR ADJUSTING SAME

(71) Applicant: SHIMADZU CORPORATION, Kyoto-shi (JP)

(72) Inventors: Yuka MORITANI, Kyoto-shi (JP); Naoya FUJIWARA, Kyoto-shi (JP); Fumiya KATSUTANI, Kyoto-shi (JP); Tomoyo TAO, Kyoto-shi, (JP)

(21) Appl. No.: 18/728,427

(22) PCT Filed: Dec. 21, 2022
(86) PCT No.: PCT/JP2022/047133

§ 371 Date: Nov. 25, 2024

(30) Foreign Application Priority Data
Jan. 12, 2022 (JP) 2022-002871

(51) Int. Cl. G02B 21/36; G01N 21/65; G02B 21/16

(52) U.S. Cl. CPC G02B 21/365; G01N 21/65; G02B 21/16; G01N 2201/06113; G01N 2201/0636

(57) ABSTRACT

A camera captures a surface image of a sample. A reference position setting processing unit changes the focal position of the laser light with respect to the sample on a stage to set the focal position at which a spot area of the laser light on the surface image meets a predetermined first criterion as a reference position. A determination processing unit determines whether or not the light quantity incident on the slit provided in front of the detector meets a predetermined second criterion based on the change in the spot position of the laser light on the surface image by changing the focal position in the depth direction with respect to the reference position. An angle adjustment processing unit adjusts the angle of the mirror when it is determined that the light quantity incident on the slit does not meet the predetermined second criterion.

### TECHNICAL FIELD

The present invention relates to a Raman microscope and a method for adjusting the same, in which a mirror reflects laser light to irradiate a sample on a stage with the laser light, and Raman scattered light from the sample is spectrally dispersed and received by a detector.

### BACKGROUND ART

In a Raman microscope, which is one example of a Raman spectrometer, laser light is focused on a sample on a stage, and the Raman scattered light from the sample is received by a detector (see, for example, Patent Document 1 listed below).

### PRIOR ART DOCUMENT

### Patent Document

Patent Document 1: Japanese Unexamined Patent Application Publication No. H10-90064

### SUMMARY OF THE INVENTION

### Problems to be Solved by the Invention

In a Raman microscope as described above, the laser light from the light source can be guided to the sample on the stage by reflecting the light from a mirror. The angle of the optical axis of the laser light incident on the sample changes according to the angle of this mirror.

The light from the sample that has passed through a slit or a pinhole is incident on the detector. Therefore, the worker, such as a user or a field engineer, adjusts the focal position, the angle of the mirror, etc., so that the light quantity incident on the slit or the pinhole is maximized. However, it is not easy to determine whether or not the light quantity incident on the slit or the pinhole is maximum, and it is also complicated to adjust the stage position and/or the mirror angle based on the resulting determination.

The present invention has been made in view of the above-described circumstances and aims to provide a Raman microscope and a method for adjusting it, in which the light quantity incident on a slit or a pinhole can be easily adjusted.

### Means for Solving the Problems

A first aspect of the present invention relates to a Raman microscope in which laser light is reflected by a mirror to irradiate a sample on a stage with the laser light, and Raman scattered light from the sample is spectrally dispersed and received by a detector. The Raman microscope is provided with an imaging unit, a reference position setting processing unit, a determination processing unit, and an angle adjustment processing unit. The imaging unit is configured to capture a surface image of the sample. The reference position setting processing unit is configured to change a focal position of the laser light with respect to the sample on the stage to set the focal position at which a spot area of the laser light on the surface image meets a predetermined first criterion as a reference position. The determination processing unit is configured to change the focal position in a depth direction with respect to the reference position to determine whether or not light quantity incident on a slit or a pinhole provided in front of the detector meets a predetermined second criterion, based on a change in a spot position of the laser light on the surface image. The angle adjustment processing unit is configured to adjust an angle of the mirror when it is determined that the light quantity incident on the slit or the pinhole does not meet the predetermined second criterion.

A second aspect of the present invention relates to a method for adjusting a Raman microscope in which laser light is reflected by a mirror to irradiate a sample on a stage with the laser light, and Raman scattered light from the sample is spectrally dispersed and received by a detector. The method comprises an imaging step, a reference position setting step, a determination step, and an angle adjustment step. In the imaging step, a surface image of the sample is captured. In the reference position setting step, a focal position of the laser light with respect to the sample on the stage is changed to set the focal position at which a spot area of the laser light on the surface image meets a predetermined first criterion as a reference position. In the determination step, the focal position in a depth direction with respect to the reference position is changed to determine whether or not the light quantity incident on the slit or the pinhole provided in front of the detector meets a predetermined second criterion based on a change in a spot position of the laser light on the surface image. In the angle adjustment step, when it is determined that the light quantity incident on the slit or the pinhole does not meet the predetermined second criterion, the angle of the mirror is adjusted.

### Effects of the Invention

According to the present invention, the light quantity incident on the slit or the pinhole can be easily adjusted.

### BRIEF DESCRIPTION OF THE DRAWINGS

FIG. 1 is a schematic diagram of a configuration example of a Raman microscope.

FIG. 2 is a block diagram showing one example of an electrical configuration of the Raman microscope.

FIG. 3A is a diagram showing one example of a surface image of a sample and shows the change in a spot area when the focal position of the laser light with respect to the sample on the stage is changed.

FIG. 3B is a diagram showing one example of a surface image of the sample and shows the change in the spot area when the focal position of the laser light with respect to the sample on the stage is changed.

FIG. 3C is a diagram showing one example of a surface image of the sample and shows the change in the spot area when the focal position of the laser light with respect to the sample on the stage is changed.

FIG. 4A is a diagram showing one example of a surface image of the sample and shows the change in the spot position when the angle of the mirror is changed.

FIG. 4B is a diagram showing one example of a surface image of the sample and shows the change in the spot area when the focal position of the laser light with respect to the sample on the stage is changed.

FIG. 5 is a flowchart for explaining the adjustment processing of the Raman microscope.

### EMBODIMENTS FOR CARRYING OUT THE INVENTION

### 1. Configuration of Raman Microscope

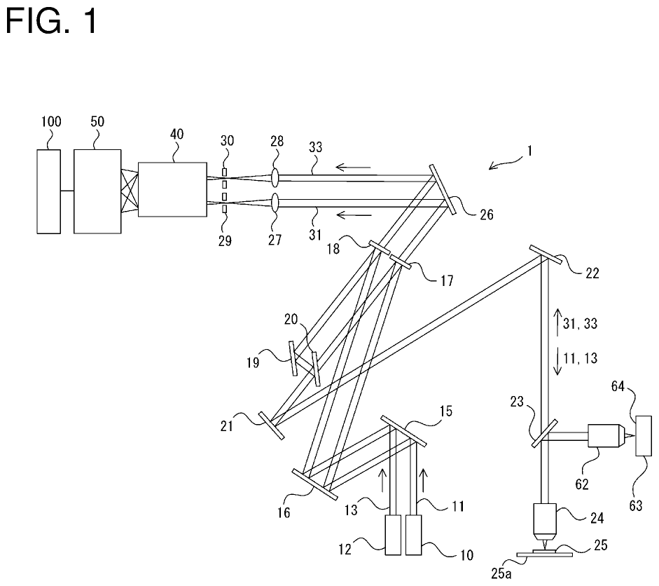

FIG. 1 is a schematic diagram showing a configuration example of a Raman microscope 1. In the following descriptions, although a specific configuration of the Raman microscope 1 will be described, it should be noted that it is not limited to this configuration, and at least some of components may be omitted, or other components may be provided.

The Raman microscope 1 is equipped with, for example, a first laser light source 10, a second laser light source 12, a stage 25a, spectroscopic optics 40, a detector 50, a controller 100, a plurality of mirrors 15, 16, 19, 21, 22, 26, a plurality of low-pass filters 17, 18, a dichroic mirror 20, an objective lens 24, a plurality of focusing lenses 27, 28, and a plurality of slits 29, 30. Note that some of the mirrors (e.g., mirrors 16, 19, 21, 22, etc.) may be omitted.

The above-described components provided in the Raman microscope 1 are components for performing Raman spectroscopic analysis by irradiating a sample 25 with laser light and spectrally dispersing and detecting the Raman scattered light emitted from the sample 25 excited by the laser light. At least some of these optical components, such as the plurality of mirrors 15, 16, 19, 21, 22, 26, the plurality of low-pass filters 17, 18, the dichroic mirror 20, and the plurality of focusing lenses 27, 28 may be configured such that their positions and/or angles can be adjusted.

Apart from the above-described components, the Raman microscope 1 is equipped with, for example, a half mirror 23, an imaging lens 62, and a camera 63. These components are used to capture a visible image of the sample surface where the Raman scattered light is generated.

The first laser light source 10 emits first laser light 11. The second laser light source 12 emits second laser light 13 having a wavelength shorter than that of the first laser light 11. As described above, in this embodiment, it is possible to excite the sample 25 using two laser light sources 10 and 12, which emit laser light 11 and 13, respectively, with different wavelengths. Note that the number of laser light sources provided in the Raman microscope 1 is not limited to two but may be one, three, or more.

The laser light source can be configured by a laser oscillator, such as a diode-pumped solid-state laser, a helium-neon laser, a Ti-Sapphire laser, or an Nd:YAG laser. Further, in the case of a configuration in which laser light from a laser oscillator is guided by a light guide such as an optical fiber, an output tube, etc., provided at the tip end of the optical fiber may constitute a laser light source.

The sample 25 is supported on the stage 25a. In this embodiment, either the first laser light 11 or the second laser light 13 can be irradiated onto the sample 25, depending on the sample 25. First Raman scattered light 31 is emitted from the sample 25 when excited by the irradiation of the first laser light 11. On the other hand, second Raman scattered light 33 is emitted from the sample 25 when excited by the irradiation of the second laser light 13.

Since the shorter the excitation wavelength, the higher the efficiency of Raman scattering, it is preferable to irradiate the sample 25 with the second laser light 13 instead of the first laser light 11 when increasing the intensity of Raman scattered light. On the other hand, when the fluorescence emitted from the sample 25 is too strong when the second laser light 13 is irradiated onto the sample 25, it is preferable to irradiate the sample 25 with the first laser light 11 instead of the second laser light 13.

The first laser light 11 emitted from the first laser light source 10 is reflected by the mirrors 15 and 16 and is incident on the low-pass filter 17. The low-pass filter 17 reflects the first laser light 11 and transmits the first Raman scattered light 31. Therefore, the first laser light 11 incident on the low-pass filter 17 is reflected by the low-pass filter 17 and then incident on the dichroic mirror 20.

The dichroic mirror 20 transmits the first laser light 11 and the first Raman scattered light 31, and reflects the second laser light 13 and the second Raman scattered light 33. Therefore, the first laser light 11 incident on the dichroic mirror 20 is transmitted through the dichroic mirror 20, sequentially reflected by the mirrors 21 and 22, and then irradiated through the half mirror 23 and the objective lens 24 onto the sample 25. At this time, the first laser light 11 is focused by passing through the objective lens 24 and irradiated as a spot on the surface of the sample 25. The focal position of the first laser light 11 focused by the objective lens 24 is not limited to the surface of the sample 25 but may be located inside or outside the sample 25.

The second laser light 13 emitted from the second laser light source 12 is reflected by the mirrors 15 and 16 and incident on the low-pass filter 18. The low-pass filter 18 reflects the second laser light 13 and transmits the second Raman scattered light 33. Therefore, the second laser light 13 incident on the low-pass filter 18 is reflected by the low-pass filter 18, sequentially reflected by the mirror 19, the dichroic mirror 20, and the mirrors 21 and 22, and then irradiated onto the sample 25 through the half mirror 23 and the objective lens 24. At this time, the second laser light 13 is focused by passing through the objective lens 24 and irradiated as a spot on the surface of the sample 25. The focal position of the second laser light 13 focused by the objective lens 24 is not limited to the surface of the sample 25 but may be located inside or outside the sample 25.

The first Raman scattered light 31 emitted from the sample 25 irradiated by the first laser light 11 has a wavelength longer than that of the first laser light 11. The first Raman scattered light 31 passes through the objective lens 24, is reflected sequentially by the mirrors 22 and 21, then transmitted through the dichroic mirror 20 and the low-pass filter 17, and is reflected by the mirror 26. The first Raman scattered light 31 reflected by the mirror 26 is focused by the focusing lens 27, then passes through the slit 29 and is incident on the spectroscopic optics 40. Note that, however, it may be configured such that a pinhole may be provided instead of the slit 29 and that the first Raman scattered light 31 is incident on the spectroscopic optics 40 through the pinhole.

The second Raman scattered light 33 emitted from the sample 25 irradiated by the second laser light 13 has a wavelength longer than that of the second laser light 13. Further, the second Raman scattered light 33 has a wavelength shorter than that of the first Raman scattered light 31. The second Raman scattered light 33 passes through the objective lens 24, is sequentially reflected by the mirrors 22, 21, the dichroic mirror 20, and the mirror 19, then transmitted through the low-pass filter 18 and reflected by the mirror 26. The second Raman scattered light 33 reflected by the mirror 26 is focused by the focusing lens 28 and then passes through the slit 30 and is incident on the spectroscopic optics 40. Note that, however, it may be configured such that a pinhole is provided instead of the slit 30 and that the second Raman scattered light 33 is incident onto the spectroscopic optics 40 through the pinhole.

The spectroscopic optics 40 is equipped with, for example, a collimator lens, a spectrometer, and a focusing optical element (all not illustrated). The spectrometer is equipped with a spectro-optical element, such as, e.g., a grating and a prism. The first Raman scattered light 31 and the second Raman scattered light 33 incident on the spectroscopic optics 40 are spectroscopically dispersed by different spectroscopic optical elements, and the first Raman scattered light 31 and the second Raman scattered light 33, separated by wavelength, are focused by the focusing optical elements and received by the detector 50.

As the detector 50, for example, a CCD (Charge Coupled Device) detector is exemplified. The detector 50 is equipped with a plurality of photodetectors and is configured to output a signal according to the received light intensity of the first Raman scattered light 31 or the second Raman scattered light 33 at each photodetector. The electrical signal output from the detector 50 is processed by the controller 100, which is electrically connected to the detector 50.

The camera 63 is an imaging unit for capturing the surface image of the sample 25. The light from the sample surface from which Raman scattered light is emitted passes through the objective lens 24, is reflected by the half mirror 23, and then imaged by the imaging lens 62 on the light-receiving surface 64 of the camera 63. The camera 63 includes, for example, a CCD (Charge Coupled Device) image sensor or a CMOS (Complementary Metal Oxide Semiconductor) image sensor and is configured to capture still or moving image of the sample 25. The camera 63 can capture all or at least one of the following images of the sample 25: a bright field image, a dark field image, a phase contrast image, a fluorescence image, and a polarized light microscope image.

In this embodiment, the adjustment (optical axis adjustment) of the Raman microscope 1 is performed by adjusting the angle of the mirror 15 so that the light quantity of the Raman scattered light from the sample 25 incident on the slits 29 and 30 provided in front of the detector 50 is maximized before performing the Raman spectroscopic analysis. At this time, a calibration sample 25 with a flat surface is placed on the stage 25a instead of an actual sample to be analyzed. The calibration sample 25 is irradiated with laser light (the first laser light 11 or the second laser light 13), and the image of the laser light spot on the sample surface is captured by the camera 63. The adjustment of the Raman microscope 1 is performed based on the area (spot area) and the position (spot position) of the spot of the laser light on the surface image of the sample 25 captured by the camera 63.

### 2. Electrical Configuration of Raman Microscope

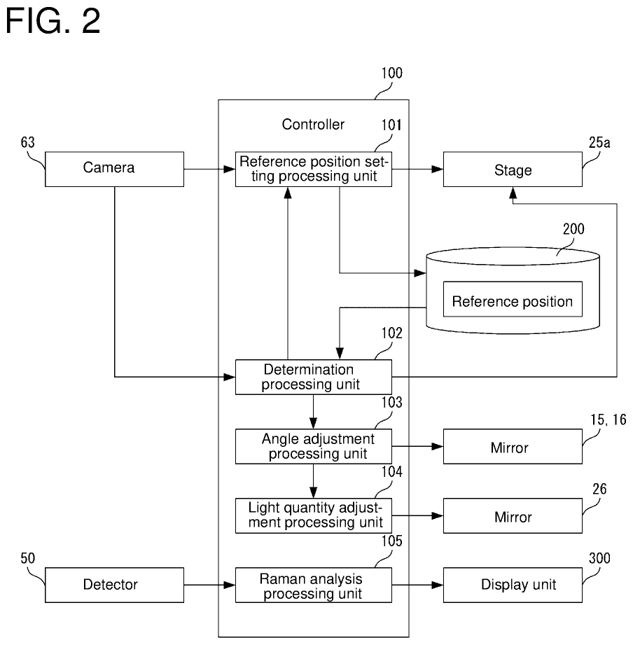

FIG. 2 is a block diagram showing one example of the electrical configuration of the Raman microscope 1. The Raman microscope 1 is equipped with a storage unit 200 and a display unit 300, in addition to the above-described components.

The controller 100 is configured to include, for example, a CPU (Central Processing Unit). The controller 100 functions as a reference position setting processing unit 101, a determination processing unit 102, an angle adjustment processing unit 103, a light quantity adjustment processing unit 104, and a Raman analysis processing unit 105 through a CPU executing a program. The reference position setting processing unit 101, the determination processing unit 102, the angle adjustment processing unit 103, and the light quantity adjustment processing unit 104 perform processing for adjusting the Raman microscope 1 performed prior to Raman spectroscopic analysis.

The reference position setting processing unit 101 performs processing to set a reference position of the focal position of the laser light based on the spot area of the laser light on the surface image of the sample 25 (calibration sample) captured by the camera 63. Specifically, when the stage 25a is moved within a predetermined range in the vertical direction, the focal position of the laser light with respect to the sample 25 on the stage 25a changes along the depth direction, which is the irradiation direction (optical axis direction) of the laser light with respect to the sample 25. At this time, as the focal position of the laser light changes, the spot area of the laser light on the surface image of the sample 25 changes.

The reference position setting processing unit 101 calculates the change in the spot area and sets the focal position at which the spot area reaches a minimum value as the reference position. Note that, however, the “minimum value” is one example of the “predetermined first criterion,” and the focal position at which the spot area meets another criterion may be set as the reference position. The position information on the reference position set by the reference position setting processing unit 101 is stored in the storage unit 200. The storage unit 200 includes a nonvolatile memory, such as, e.g., a hard disk.

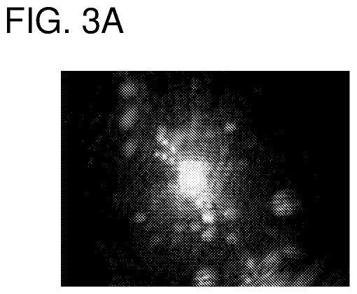

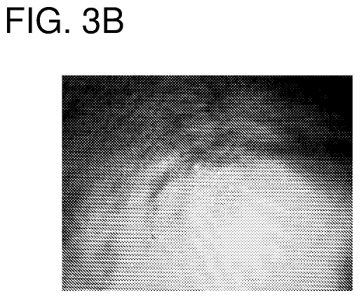

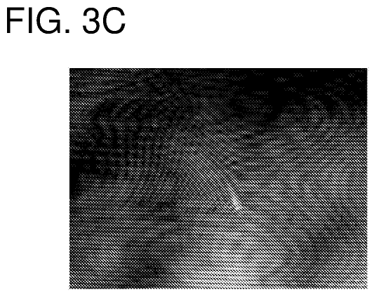

FIG. 3A to FIG. 3C are diagrams each showing one example of the surface image of the sample 25 and showing the change in the spot area when the focal position of the laser light with respect to the sample 25 on the stage 25a is changed.

The surface image of the sample 25 when setting the reference position of the focal position of the laser light is a microscopic image taken with the exposure time and the gain of the camera 63 both set to minimum values. Further, the spot area of the laser light on the surface image of the sample 25 can be calculated by determining the bright area in the binarized surface image of the sample 25 as the spot area.

When the focal position of the laser light is at the reference position (optimal position), the spot area becomes a minimum value, as shown in FIG. 3A. In contrast, when the focal position of the laser light is displaced in the depth direction relative to the reference position, the spot area becomes larger than that in FIG. 3A, as shown in FIG. 3B. Further, when the focal position of the laser light is further shifted in the depth direction from the state shown in FIG. 3B with respect to the reference position, as shown in FIG. 3C, the intensity of the laser light becomes weaker. Additionally, the spot of the laser light does not fit within the surface image of the sample 25. Therefore, the value calculated as the spot area becomes smaller.

Referring again to FIG. 2, the determination processing unit 102 determines whether or not the light quantity incident on the slit 29, 30 provided in front of the detector 50 is maximum, based on the spot position of the laser light on the surface image of the sample 25 (calibration sample) captured by the camera 63. Specifically, as the stage 25a is moved in the vertical direction within a predetermined range, the focal position of the laser light changes in the depth direction relative to the reference position. Note that, however, instead of determining whether or not the light quantity incident on the slit 29, 30 is the maximum, it may be determined whether or not the light quantity meets another criterion (predetermined second criterion).

When the light quantity incident on the slit 29, 30 is not maximum, the spot position of the laser light on the surface image of the sample 25 changes when the focal position of the laser light on the sample 25 on the stage 25a is changed along the depth direction. The determination processing unit 102 calculates the change in the spot position (change in the center of gravity of the spot) and compares the amount of change with a threshold to determine whether or not the light quantity incident on the slit 29, 30 is maximum.

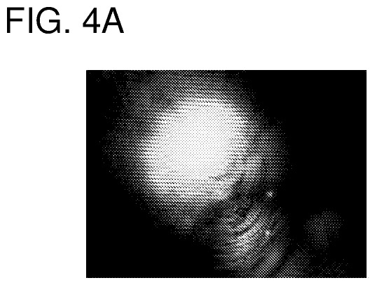

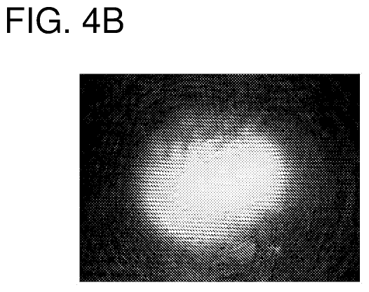

FIG. 4A and FIG. 4B are diagrams each showing an example of the surface image of the sample 25 and show the change in the spot position as the angle of the mirror is changed.

If the light quantity incident on the slit 29, 30 is not maximum, as shown in FIG. 4A, the spot position is shifted from the reference position when the focal position of the laser light on the sample 25 on the stage 25a is changed along the depth direction. In contrast, when the light quantity incident on the slit 29, 30 is maximum, as shown in FIG. 4B, the spot position does not deviate from the reference position even if the focal position of the laser light is changed along the depth direction.

Referring to FIG. 2, the angle adjustment processing unit 103 adjusts the angle of the mirror 15 when the light quantity incident on the slit 29, 30 is determined to not be at maximum by the determination processing unit 102. The angle of the mirror 15 can be adjusted, for example, by controlling the applied voltage to a piezoelectric element (not illustrated). Note that, however, the angle of the mirror 15 can be adjusted using any other mechanism, not limited to mechanisms using a piezoelectric element.

As shown in FIG. 1, the laser light before irradiating the sample 25 is incident on the mirror 15, but the light from the sample 25 does not incident on the mirror 15. Therefore, by adjusting the angle of the mirror 15, the angle of the optical axis of the laser light incident on the sample 25 changes. As a result, the angle of the light incident on the detector 50 from the sample 25 also changes. In this embodiment, by adjusting the angle of the mirror 15, it is possible to adjust the light quantity from the sample 25 incident on the slit 29, 30 to be maximum. The adjustment amount (change amount) of the angle of the mirror 15 at this time can be calculated based on the change amount of the spot position of the laser light during the determination processing.

The light quantity adjustment processing unit 104 performs processing to adjust the light quantity received by the detector 50 after the processing by the angle adjustment processing unit 103 is performed. Specifically, the optical axis of the light incident on the detector 50 is adjusted by adjusting the angle of the mirror 26 so that the light intensity received by the detector 50 is maximized. The angle of the mirror 26 can be adjusted, for example, by controlling the applied voltage to a piezoelectric element (not illustrated). Note that, however, the angle of the mirror 26 can be adjusted using any other mechanism, not limited to mechanisms using a piezoelectric element. Further, instead of adjusting the angle of the mirror 26 to maximize the quantity of light received by the detector 50, the angle of the mirror 26 may be adjusted so that the light quantity meets another criterion (predetermined third criterion).

As shown in FIG. 1, the light from the sample 25 is incident on the mirror 26, and the light reflected by the mirror 26 is detected by the detector 50 through the slit 29, 30. Therefore, by adjusting the angle of the mirror 26, the light quantity passing through the slit 29, 30 changes. Consequently, the light quantity received by the detector 50 also changes.

The Raman analysis processing unit 105 performs processing to perform a Raman spectroscopic analysis on the sample 25 on the stage 25a. Specifically, the Raman spectrum is acquired based on the detection signal from the detector 50. The Raman spectrum acquired by the Raman spectroscopic analysis may be displayed on the display unit 300 by the Raman analysis processing unit 105. The display unit 300 has a configuration that includes, but is not limited to, a liquid crystal display.

### 3. Adjustment Processing of Raman Microscope

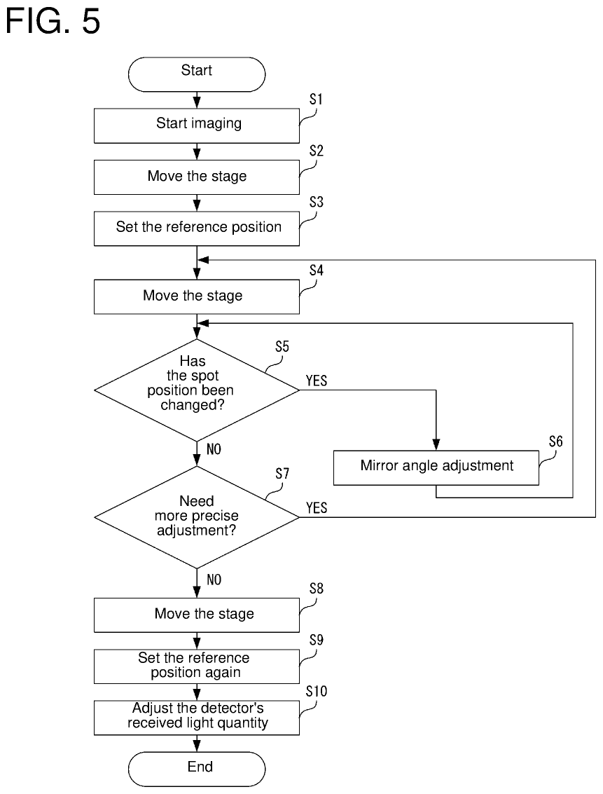

FIG. 5 is a flowchart for explaining the adjustment processing of the Raman microscope 1. The adjustment processing of the Raman microscope 1 shown in FIG. 5 is performed by the controller 100 before the Raman spectroscopic analysis to perform the Raman spectroscopic analysis well. The adjustment processing may be initiated automatically under the control of the controller 100, or may be initiated based on the operation of an operation unit (not illustrated) by a worker, such as a user or a field engineer.

When the adjustment processing of the Raman microscope 1 is initiated, in a state in which the sample 25 is irradiated with the laser light, the capturing of the surface image of the sample 25 by the camera 63 is initiated (Step S1: Imaging Step). Thereafter, the stage 25a is moved to change the focal position of the laser light on the sample 25 on the stage 25a along the depth direction, and the focal position at which the spot area of the laser light on the surface image of the sample 25 becomes a minimum value is set as the reference position

### (Steps S2 to S3: Reference Position Setting Step).

Once the reference position is set, the stage 25a is moved again to change the focal position in the depth direction relative to the reference position, and it is determined whether or not the spot position of the laser light on the surface image of the sample 25 has changed (Steps S4 to S5: Determination Step). When the spot position of the laser light is changed (YES in Step S5), it is determined that the light quantity incident on the slit 29, 30 is not maximum, and the angle of the mirror 15 is adjusted (Step S6: Angle Adjustment Step).

In this case, after the angle of the mirror 15 is adjusted, Steps S5 to S6 are repeated until it is determined that the spot position has not changed (NO in Step S5), i.e., the light quantity incident on the slit 29, 30 is determined to be maximum.

In the case where it is determined that the spot position has not changed (NO in Step S5), i.e., the light quantity incident on the slit 29, 30 is determined to be maximum, and a more precise adjustment is required (YES in Step S7), as in Steps S4 to S6, the stage 25a is moved to change the focal position of the laser light with respect to the sample 25 on the stage 25a along the depth direction, and it is redetermined whether or not the spot position of the laser light on the surface image of the sample 25 has changed. In the case where the spot position of the laser light is changed, it is determined again that the light quantity incident on the slit 29, 30 is not maximum, and the angle of the mirror 15 is adjusted again. With this, the fine adjustment of the mirror 15 is performed. Note that, however, the fine adjustment of the mirror 15 may be omitted.

After the fine adjustment of the mirror 15 is performed (NO in Step S7), as in Steps S2 to S3, the stage 25a is moved to change the focal position of the laser light along the depth direction, and the focal position at which the spot area of the laser light on the surface image of the sample 25 becomes a minimum value is set again as a reference position (Steps S8 to S9). With this, the fine adjustment of the reference position is performed. Note that, however, the fine adjustment of the reference position may be omitted.

Thereafter, the angle of the mirror 26 is adjusted to adjust the optical axis of the light incident on the detector so that the light quantity received by the detector 50 is maximized (Step S9: Light Quantity Adjustment Step).

### 4. Aspects

It would be understood by those skilled in the art that the plurality of exemplary embodiments described above is specific examples of the following aspects.

### (Item 1)

A Raman microscope according to one aspect of the present invention is a Raman microscope in which laser light is reflected by a mirror to irradiate a sample on a stage with the laser light, and Raman scattered light from the sample is spectrally dispersed and received by a detector.

The Raman microscope includes:
an imaging unit configured to capture a surface image of the sample;
a reference position setting processing unit configured to change a focal position of the laser light with respect to the sample on the stage to set the focal position at which a spot area of the laser light on the surface image meets a predetermined first criterion as a reference position;
a determination processing unit configured to change the focal position in a depth direction with respect to the reference position to determine whether or not light quantity incident on a slit or a pinhole provided in front of the detector meets a predetermined second criterion, based on a change in a spot position of the laser light on the surface image; and
an angle adjustment processing unit configured to adjust an angle of the mirror when it is determined that the light quantity incident on the slit or the pinhole does not meet the predetermined second criterion.

According to the Raman microscope as recited in the above-described Item 1, after setting the reference position of the focal position of the laser light, it is possible to change the focal position in the depth direction with respect to the reference position to determine whether or not the light quantity incident on the slit or the pinhole meets the predetermined second criterion, based on the change in the spot position of the laser light on the surface image of the sample. By adjusting the angle of the mirror based on this determination result, the light quantity incident on the slit or the pinhole can be easily adjusted.

### (Item 2)

In the Raman microscope as recited in the above-described Item 1, it may be configured such that processing by the angle adjustment processing unit is repeatedly performed until the determination processing unit determines that the light quantity incident on the slit or the pinhole meets the predetermined second criterion.

According to the Raman microscope as recited in the above-described Item 2, even if the light quantity incident on the slit or the pinhole does not meet the predetermined second criterion after only one angular adjustment of the mirror, by repeatedly performing the angular adjustment of the mirror, it is possible to adjust the light quantity incident on the slit or the pinhole to assuredly meet the predetermined second criterion. After the light quantity incident on the slit or the pinhole is determined by the determination processing unit to meet the predetermined second criterion, the re-determination by the determination processing unit and the reprocessing by the angle adjustment processing unit may be performed.

### (Item 3)

In the Raman microscope as recited in the above-described Item 1 or 2, it may be configured such that after the processing by the angle adjustment processing unit is performed, the reference position is set again by the reference position setting processing unit.

According to the Raman microscope as recited in the above-described Item 3, after adjusting the angle of the mirror so that the light quantity incident on the slit or the pinhole meets the predetermined second criterion, the reference position of the focal position of the laser light can be finely adjusted.

### (Item 4)

In the Raman microscope as recited in any one of the above-described Items 1 to 3, further comprising:
a light quantity adjustment processing unit configured to adjust, after the processing by the angle adjustment processing unit is performed, an optical axis of the light incident on the detector so that the light quantity received by the detector meets a predetermined third criterion.

According to the Raman microscope as recited in the above-described Item 4, after adjusting the angle of the mirror so that the light quantity incident on the slit or the pinhole meets the predetermined second criterion, the light intensity incident on the detector can be adjusted.

### (Item 5)

A method for adjusting a Raman microscope according to one aspect of the present invention is a method for adjusting a Raman microscope in which laser light is reflected by a mirror to irradiate a sample on a stage with the laser light, and Raman scattered light from the sample is spectrally dispersed and received by a detector.

The method comprises:
an imaging step of capturing a surface image of the sample;
a reference position setting step of changing a focal position of the laser light with respect to the sample on the stage to set the focal position at which a spot area of the laser light on the surface image meets a predetermined first criterion as a reference position;
a determination step of changing the focal position in a depth direction with respect to the reference position to determine whether or not light quantity incident on the slit or the pinhole provided in front of the detector meets a predetermined second criterion based on a change in a spot position of the laser light on the surface image; and
an angle adjustment step of adjusting an angle of the mirror when it is determined that the light quantity incident on the slit or the pinhole does not meet the predetermined second criterion.

According to the method for adjusting the Raman microscope, as recited in the above-described Item 5, after setting the reference position of the focal position of the laser light, it is possible to change the focal position in the depth direction with respect to the reference position to determine whether or not the light quantity incident on the slit or the pinhole meets the prescribed second criterion based on the change in the spot position of the laser light on the surface image of the sample. By adjusting the angle of the mirror based on this determination result, the light quantity incident on the slit or the pinhole can be easily adjusted.

### (Item 6)

In the method for adjusting the Raman microscope, as recited in the above-described Item 5, it may be configured such that the angle adjustment step is repeatedly performed until it is determined in the determination step that the light quantity incident on the slit or the pinhole meets the predetermined second criterion.

According to the method for adjusting the Raman microscope, as recited in the above-described Item 6, even if the light quantity incident on the slit or the pinhole does not meet the predetermined second criterion after only one angular adjustment of the mirror, by repeatedly performing the angular adjustment of the mirror, it is possible to adjust the light quantity incident on the slit or the pinhole to assuredly meet the predetermined second criterion. After the light quantity incident on the slit or the pinhole is determined in the determination step to meet the predetermined second criterion, the re-determination in the determination step and the reprocessing in the angle adjustment step may be performed.

### (Item 7)

In the method for adjusting the Raman microscope, as recited in claim 5 or 6, it may be configured such that after the angle adjustment step is performed, the reference position is set again in the reference position setting step.

According to the Raman microscope as recited in the above-described Item 7, after adjusting the angle of the mirror so that the light quantity incident on the slit or the pinhole meets the predetermined second criterion, it is possible to finely tune the reference position of the focal position of the laser light.

### (Item 8)

In the method for adjusting the Raman microscope, as recited in any one of the above-described Items 5 to 7, it may be configured to further comprise:
a light quantity adjustment step of adjusting, after the angle adjustment step is performed, an optical axis of the light incident on the detector so that the light quantity received by the detector meets a predetermined third criterion.

According to the method for adjusting the Raman microscope, as recited in the above-described Item 8, after adjusting the angle of the mirror so that the light quantity incident on the slit or the pinhole meets the predetermined third criterion, the light intensity incident on the detector can be adjusted.

### DESCRIPTION OF REFERENCE SYMBOLS

1: Raman microscope
10: First laser light source
11: First laser light
12: Second laser light source
13: Second laser light
15, 16, 26: Mirror
25: Sample
25A: Stage
31: First Raman scattered light
33: Second Raman scattered light
50: Detector
63: Camera
100: Controller
101: Reference position setting processing unit
102: Determination processing unit
103: Angle adjustment processing unit
104: Light quantity adjustment processing unit

1. A Raman microscope in which a laser light is reflected by a plurality of mirrors to irradiate a sample on a stage with the laser light, Raman scattered light from the sample is spectrally dispersed and received by a detector, and a light source which emits the laser light, the stage, and the detector are optically connected, the Raman microscope comprising:
an imaging unit configured to capture a surface image of the sample;
a reference position setting processing unit configured to change a focal position of the laser light with respect to the sample on the stage in a depth direction to set the focal position at which a captured spot area of the laser light in the surface image satisfies a predetermined first criterion value, the set focal position indicating a reference position;
a determination processing unit configured to change the focal position in a depth direction with respect to the reference position and to control the imaging unit to capture at least two images of the sample such that a captured spot position of the laser light in the at least two surface images of the sample changes in accordance with the changes of the focal position to determine whether or not a light quantity incident on a slit or a pinhole provided in front of the detector meets a predetermined second criterion, the second criterion changing in response to the spot position of the laser light in the at least two images; and
an angle adjustment processing unit configured to adjust an angle of the mirror when it is determined that the light quantity incident on the slit or the pinhole does not meet the predetermined second criterion.

2. The Raman microscope as recited in claim 1,
wherein processing by the angle adjustment processing unit is repeatedly performed until the determination processing unit determines that the light quantity incident on the slit or the pinhole meets the predetermined second criterion.

3. The Raman microscope as recited in claim 1,
wherein after the processing by the angle adjustment processing unit is performed, the reference position is set again by the reference position setting processing unit.

4. The Raman microscope as recited in claim 1, further comprising:
a light quantity adjustment processing unit configured to adjust, after the processing by the angle adjustment processing unit is performed, an optical axis of the light incident on the detector so that the light quantity received by the detector meets a predetermined third criterion.

5. A method for adjusting a Raman microscope in which a laser light is reflected by a plurality of mirrors to irradiate a sample on a stage with the laser light, Raman scattered light from the sample is spectrally dispersed and received by a detector, and a light source which emits the laser light, the stage, and the detector are optically connected, the method comprising:
an imaging step of capturing a surface image of the sample;
a reference position setting step of changing a focal position of the laser light with respect to the sample on the stage in a depth direction to set the focal position at which a captured spot area of the laser light in the surface image satisfies a predetermined first criterion value, the set focal position indicating a reference position;
a determination step of changing the focal position in a depth direction with respect to the reference position including capturing at least two surface images of the sample such that a captured spot position of the laser light in the at least two surface images of the sample changes in accordance with the changes of the focal position to determine whether or not a light quantity incident on a slit or a pinhole provided in front of the detector meets a predetermined second criterion, the second criterion changing in response to the spot position of the laser light in the at least two images; and
an angle adjustment step of adjusting an angle of the mirror when it is determined that the light quantity incident on the slit or the pinhole does not meet the predetermined second criterion.

6. The method for adjusting a Raman microscope, as recited in claim 5,
wherein the angle adjustment step is repeatedly performed until it is determined in the determination step that the light quantity incident on the slit or the pinhole meets the predetermined second criterion.

7. The method for adjusting a Raman microscope, as recited in claim 5,
wherein after the angle adjustment step is performed, the reference position is set again in the reference position setting step.

8. The method for adjusting a Raman microscope, as recited in claim 5, further comprising:
a light quantity adjustment step of adjusting, after the angle adjustment step is performed, an optical axis of the light incident on the detector so that the light quantity received by the detector meets a predetermined third criterion.
